(19) United States
(12) Patent Application Publication
(10) Pub. No.: US 2024/0139996 A1
(43) Pub. Date: May 2, 2024

(54) METHOD OF ADDITIVELY MANUFACTURING A COMPONENT, LOAD TRANSFER ELEMENT, REINFORCEMENT FOR USE WITHIN A COMPONENT, AND ACTIVELY MANUFACTURED COMPONENT

(71) Applicant: PERI SE, Weissenhorn (DE)

(72) Inventor: Juergen MAYER, Weissenhorn (DE)

(21) Appl. No.: 18/547,983

(22) PCT Filed: Apr. 6, 2022
(86) PCT No.: PCT/EP2022/059133

§ 371 Date: Aug. 25, 2023

(30) Foreign Application Priority Data
Apr. 7, 2021 (DE) 10 2021 108 666.3

(51) Int. Cl. B28B 1/00; B33Y 10/00; E04G 21/04; E04G 21/12

(52) U.S. Cl. CPC B28B 1/001; B33Y 10/00; E04G 21/04; E04G 21/12

(57) ABSTRACT

In a method of additively manufacturing a component from a building material, a material output unit deposits the building material in layers along a defined print pathway. At least, one load transfer element extends into the print pathway. The material output unit deposits the building material onto the load transfer element present in the print pathway, and a load transfer element present in a movement pathway of the material output unit is at least temporarily pushed out of the print pathway by the material output unit while the material output unit deposits the building material along the defined print pathway.

### CROSS-REFERENCE TO RELATED APPLICATIONS

The present application is the U.S. national phase of International Application No. PCT/EP2022/059133 filed Apr. 6, 2022, which designated the U.S. and claims priority to German patent application No. 10 2021 108 666.3 filed Apr. 7, 2021, the entire contents of each of which are incorporated herein by reference in their entirety.

### BACKGROUND

The invention relates to a method of additively manufacturing a component from a building material, according to which a material output unit deposits the building material in layers.

The invention further relates to a computer program and an additively manufactured component.

Furthermore, the invention relates to a load transfer element, as well as a reinforcement for use within a component, in particular within an additively manufactured component.

Methods for additively manufacturing three-dimensional objects are known for manufacturing models, prototypes, tools and end products, for example. In this case, starting materials in the form of liquids, powders or filaments made of thermoplastic plastics are deposited by a print head attached to an end effector of an actuator device in order to build up the object in layers based on 3D data of the object to be manufactured. Such a method is also referred to, inter alia, as a “generative manufacturing method” or “3D printing.”

In the meantime, it is also known to use additive manufacturing methods for manufacturing entire structures or components of structures (for example walls or formwork). The additive manufacturing of buildings or components thereof can significantly increase productivity in the construction industry. As a result of so-called “3D concrete printing,” structures can be produced faster and at lower costs. With the aid of a 3D concrete printer, concrete structures can be realized quickly and economically, while at the same time having maximum design freedom.

So-called reinforcements are known for reinforcing components from the construction industry. Increased bearing and/or tensile strength can result from combining the building material with the reinforcement, for example a reinforcing steel. The combination of a 3D printer and the use of a reinforcement is sometimes difficult, in particular if manual interventions are to be minimized as much as possible.

In order to produce a good connection between the building material and the reinforcement, it is known to first “print” a formwork around the reinforcement and then fill the formwork with an additional building material. The formwork is therefore initially generally completely free and is thereby susceptible to horizontal forces. The pressure of the additional building material introduced into the formwork, for example concrete, can ultimately press apart or even break the formwork.

In order to increase the stability of a classic formwork (for example a wooden formwork), so-called formwork anchors are used in the construction industry and extend from a formwork component to the opposite formwork component, that is to say from one side of the formwork to the other side of the formwork, in order to stabilize the formwork during the filling and curing of the additional component. Subsequently, the formwork anchors can be removed again in order to release the formwork from the finished component. These manual work steps are comparatively complicated and cannot be carried out within the context of additive manufacturing of the formwork. In particular, the problem arises of a collision of the formwork anchors with the material output unit of the 3D concrete printer.

Not least for this reason, additive manufacturing in the construction industry, especially in the case of multi-story structures with reinforcements, is not yet regularly used in current practice.

### SUMMARY

In view of the known prior art, an object of the described embodiments is to provide a method for the additive manufacturing of components which ensures additional reinforcement of the component and preferably high process reliability.

It is also an object of the described embodiments to provide an improved load transfer element and an improved reinforcement for use within a component, in particular within an additively manufactured component.

The described embodiments are also based on the object of providing an advantageous computer program and a particularly robust additively produced component which preferably can be manufactured quickly and economically.

A method of additively manufacturing a component from a building material is provided.

The component to be manufactured can in particular be part of a structure or a formwork to be mentioned below. The component can also be a complete structure or a complete formwork. In principle, any components can be manufactured additively according to the described embodiments.

In the context of the described embodiments, building structures can be understood as structures of all types, in particular however protective structures such as buildings for the accommodation and stay of humans or animals, protective walls, dikes, shelters, enclosures, weirs and fortification systems, and city walls and prison walls. However, a structure can also be a traffic structure, for example a road, a pedestrian pathway, a bridge or a tunnel. Supply and disposal structures such as wells, sewage treatment plants, dams, chimneys or temporary structures can also be manufactured additively within the scope of the described embodiments.

Within the scope of the described embodiments, a component of a structure can in particular be a functional component of a structure, in particular a functional or geometrically cohesive part of the structure such as a wall, a support, or a stair. A building part consisting of multiple components of the structure (for example a floor or a story of a building) can also fall under the term “component” within the scope of the described embodiments. The formwork or formwork component described below can also be a component within the scope of the described embodiments, in particular if the formwork component or the formwork subsequently forms a part of the structure, for example the outer part of a wall of the building.

A base can be provided on which the component is erected. In the context of the described embodiments, a base can be understood to mean in particular subsoil and/or a foundation on which the structure or component is erected. However, the base can also be a floor of a multi-story building or a mobile, movable base. For example, it can be provided to transport the component together with the base after additive manufacturing to its intended installation site. In principle, any surface on which the component can be erected (permanently or temporarily) can be suitable as a base.

Multiple components can also be produced using the proposed method, possibly also components that are not connected to one another.

According to the described embodiments, a material output unit deposits the building material in layers along a defined print pathway.

The print pathway can be calculated based on 3D data of the component. Corresponding method steps are already known from conventional 3D printing. The 3D data of the component can in particular be three-dimensional CAD data. The component can be represented in the data in particular by point clouds, edge models, surface models and/or volume models.

A control device can be provided which controls and/or regulates the method or individual method steps.

For example, the control device can be configured to calculate the print pathway on the basis of the input 3D data. The control device can be configured, for example, to calculate a virtual model of the component in the known STL format (“standard triangulation/tesselation language” format) from the 3D data of the component. In the context of the STL format, the component data can be described with the aid of triangular facets. The principle is known and will therefore not be described in more detail. An STL interface is a standard interface of many CAD systems. In the present case, the control device can be configured to first calculate STL data for further processing from any 3D CAD data. However, the control device can also be configured to record and further process 3D data in the STL format. In principle, any other data format can also be provided.

Regardless of whether the STL data were generated by the control device itself or only transmitted to it, the control device can be configured to convert the component data into printer data for 3D printing (or for additive manufacturing) using the STL data (or using other 3D data). For this purpose, it can be provided, inter alia, to convert the 3D data or STL data into individual layers to be printed (so-called “slicing”), after which the print paths are calculated for the individual layers in order to predetermine the movements of the material output unit.

The control device can be configured to control the material output unit as a function of the print paths and/or to regulate the dispensing or deposition of the building material.

In particular, it can be provided that the material output unit is designed as a nozzle, print head or extruder in order to dispense the building material.

According to the described embodiments, at least one load transfer element extends into the print pathway (or beyond, as will be described below). The material output unit finally deposits the building material onto the load transfer element located in the print pathway. It is provided that a load transfer element located in a movement pathway of the material output unit is at least temporarily pushed out of the print pathway by the material output unit, while the material output unit deposits the building material along the defined print pathway.

In the proposed manner, the material output unit can print or move without consideration of the positions of the load transfer elements. Unintended damage to the material output unit or the actuator thereof can thereby be avoided. Because the load transfer elements are displaced by the material output unit, the material output unit can ultimately operate without interruption. This can lead to a shortened construction time. The load transfer elements therefore do not have to be introduced manually or automatically in layers. This can be advantageous because the need to lay the load transfer elements in layers usually requires printing of equal height on both sides of the reinforcement and/or can make it necessary to temporarily interrupt printing. In a preferred embodiment, the load transfer elements can be designed to be flexible or at least partially flexible in order to enable the movement.

The at least one load transfer element is configured in particular to absorb and dissipate tensile forces. In this way, the load transfer element can very easily stabilize the component, in particular a formwork which is subsequently filled with an additional building material.

According to a particularly advantageous development of the described embodiments, the print pathway extends at least sectionally along a reinforcement, starting from which the at least one load transfer element extends into the print pathway.

However, it can also be provided that a reinforcement is only provided partially, or sectionally, or not at all. The load transfer elements can be positioned and/or fixed on any holders or objects.

Reinforcements are known in principle and can be used as desired within the scope of the described embodiments. Any reinforcement or armoring can be provided which increases the load-bearing capacity in combination with the building material.

Preferably, the load transfer elements are introduced into the reinforcement or connected to the reinforcement before the additive manufacturing of the component. The load transfer elements can be fastened to the reinforcement, for example. In principle, however, the load transfer elements can also be inserted loosely into the reinforcement—this is, however, generally not preferred.

The reinforcement can be set up or laid by a professional, preferably before the start of depositing the building material by the material output unit. The reinforcement can optionally be connected to other components and/or to the base with a connecting reinforcement or in some other way. However, a free-standing, i.e., unconnected reinforcement can also optionally be provided. The position of the reinforcement can be taken into account in the 3D data when calculating the print pathway.

By using the reinforcement and in particular by connecting between the reinforcement and the at least one load transfer element, the finished component can be mechanically strengthened considerably.

In an advantageous development of the described embodiments, it can be provided that the proposed method is used for the additive manufacturing of a formwork component. The component according to the described embodiments can therefore be a formwork component. In particular, the component can be a complete formwork (i.e., a hollow mold like a casting mold) consisting of two formwork components running parallel to one another.

The described embodiments are very particularly advantageous for the additive manufacturing of a formwork, or at least one formwork component of a formwork. In principle, however, the use of the described embodiments is not to be understood to be limited to the additive manufacturing of a formwork or a formwork component.

Preferably, the aforementioned printing process is carried out from both sides of the reinforcement in order to erect a double-sided, so-called “lost formwork” around the reinforcement.

In the context of the described embodiments, a formwork, which is not to be filled afterward, can also be advantageously produced. Such formworks can be used, for example, in buildings or parts of buildings which do not have to have a high load-bearing capacity (e.g., individual walls). The cavity between such a formwork can optionally remain free or can be provided with insulation.

According to a development of the described embodiments, it can be provided that the formwork is filled with an additional building material. For this purpose, conventional concrete is preferably introduced into the finished formwork.

The additional building material can be the same building material which is also used for the additive manufacturing of the component. However, it can also be a different building material. The additional building material which is introduced into the formwork can preferably be conventional concrete, and the building material for additive manufacturing can be a concrete specifically suitable for additive manufacturing. The concrete formulation can therefore preferably differ. In principle, however, different types of materials can also be provided such as plastic for manufacturing the formwork and concrete for filling the formwork. Any combinations are possible.

According to a development of the described embodiments, it can be provided that flowable mixed concrete (“fresh concrete”) or mortar is used as building material.

Preferably, a concrete formulation with small aggregate is sought. In particular, a concrete can be provided which rapidly sets and in particular has a high green strength. It can also be provided that the concrete has one or more additives, for example in order to prevent excessively rapid drying in order to increase the pumpability and/or to modify the color.

As an alternative to the use of concrete or mortar as a building material, however, any other building material can also be provided which can be suitable for manufacturing or building structures or components thereof, in particular polymer concrete, gypsum, clay, a plastic, preferably a thermoplastic, but also metals or alloys. In principle, any building materials can be provided within the scope of the described embodiments.

In principle, the component can be produced from one, two, three, four or even more starting materials or building materials. For example, various concrete mixtures, plastics, metals and/or alloys can be combined with one another as desired.

In a further development of the described embodiments, it can be provided that the print pathway extends at least sectionally parallel to the reinforcement.

Preferably, the print pathway is spaced apart from the reinforcement or directly adjoins the reinforcement. However, the print pathway can also overlap with the reinforcement in order to at least partially introduce the building material into the reinforcement during manufacture. As a result, the stability of the component can optionally be further increased.

In a further development of the described embodiments, it can be provided that the reinforcement has a reinforcement mat and/or a reinforcing cage and/or a reinforcement rod (in particular one or more quasi-freestanding reinforcing rods, which are fastened for example to a base) and/or a reinforcement wire or a reinforcing cable (e.g., one or more prestressed reinforcement wires/reinforcing cables).

The reinforcement can in particular be made of reinforcing steel or structural steel. However, the reinforcement can also have carbon fibers, glass fibers, wood and/or plastic or can be formed from these materials. The reinforcement can have inter alia so-called reinforcement mats (grid-like structures) and/or reinforcement cages and/or reinforcement rods.

Preferably, the reinforcement is formed from at least one reinforcing cage or has at least one reinforcing cage, since a reinforcing cage can be freely erected in a sufficiently mechanically stable manner. Reinforcement cages are generally formed from two or more reinforcement mats which are connected in parallel to one another as torsion-resistant as possible in order to ensure that the reinforcing cage is stable after being erected and cannot sway or “wobble,” or only insignificantly. Normalized standard reinforcement cages can preferably be provided.

By means of the proposed method, a conventional reinforcement can advantageously be integrated in 3D-printed concrete structures, and the reinforcement can be further increased by the load transfer elements.

The reinforcement can have multiple horizontal struts and multiple vertical struts, in particular if it has a reinforcement mat or a reinforcing cage. Depending on how the reinforcement is set up, for example set up on the base, the vertical struts preferably run in the perpendicular direction of the base, and the horizontal struts preferably extend orthogonally to the vertical struts.

Insofar as the described embodiments refer to a “vertical” or “horizontal” direction, the vertical direction is to be understood in relation to the perpendicular to the base, and the horizontal direction at right angles thereto.

In an advantageous development of the described embodiments, provision can be made for the at least one load transfer element to be fastened to the reinforcement.

The at least one load transfer element can rest, for example, on two horizontal struts of the reinforcement positioned offset with respect to one another, for example fastened on the horizontal struts spaced apart from one another of a reinforcement cage or two adjacent reinforcing mats of the same height level and optionally on one or more of the horizontal struts and/or vertical struts. However, the at least one load transfer element does not necessarily have to rest on the reinforcement and can then, for example, also be fastened only laterally to the reinforcement.

Insofar as the at least one load transfer element is fastened to the reinforcement, this fastening can in principle be of any nature. Any form-fitting, force-fitting and/or material bonding fastening techniques can therefore be provided such as for example gluing, welding, a suitable deformation up to fastening by means of additional aids, such as lashing elements (e.g., cable ties). In special cases, it can even be provided that the at least one load transfer element is integrally formed with the reinforcement.

It should be emphasized again at this juncture that a reinforcement is not absolutely necessary. It can also be provided, for example, that the at least one load transfer element is fastened to a holder or another object and/or rests on a holder or another object. A fastening to the base on which the structure is erected or to a connecting reinforcement can also be provided if necessary.

In a further development of the described embodiments, it can be provided that the reinforcement is arranged between two parallel print paths.

In this case, load transfer elements preferably extend on both sides of the reinforcement up to the respective print pathway. Separate load transfer elements can be provided on each side of the reinforcement. However, particularly good reinforcement can result when the at least one load transfer element extends through the reinforcement from the first print pathway up to the second print pathway.

In an advantageous development of the described embodiments, it can be provided that the at least one load transfer element extends beyond the print pathway in order to protrude or extend laterally from the finished component after the building material has been deposited. However, the load transfer elements can also end within the print pathway or terminate with the side surface of the component.

In particular if the load transfer elements project beyond the print pathway, they can be color-coded so that in the finished component (for example a wall or a formwork component), the extent of the building material coverage or concrete coverage, that is to say the lateral overlap of the load transfer element with the building material, is made visible. Thus, for example, a still visible load transfer element can indicate a building material coverage that is too low and suggest reworking.

Optionally, it can be provided that the load transfer elements, if they later protrude laterally from the finished component, have a thread or another fastening option for a flat support element, such as a support plate or a washer, at least at their protruding free ends. In this way, the horizontal forces can be dissipated even more gently by the load transfer elements.

In an advantageous development of the described embodiments, provision can be made for several of the load transfer elements to be arranged distributed along the print pathway.

It can also be provided that several of the load transfer elements are arranged distributed over several of the layers to be deposited.

By distributing the load transfer elements over as large an area as possible, it may be possible to achieve particularly stable reinforcement of the component and gentle force transfer by the load transfer elements.

In an advantageous development of the described embodiments, provision can be made for one load transfer element to be used per layer to be deposited.

It can also be provided that at least one load transfer element is used per vertical strut of the reinforcement, which extends from the respective vertical strut to the print pathway.

For example, it can be provided that 0.1 to 20 load transfer elements are provided per square meter of formwork, e.g., 0.2 to 10 load transfer elements, 0.4 to 5 load transfer elements or exactly one load transfer element, wherein the quantity of load transfer elements depends on the diameter and/or the material of the load transfer elements, and therefore more or less load transfer elements can also be provided per square meter formwork.

In a further development of the described embodiments, it can be provided that the load transfer element, which is pushed out of the print pathway, is a load transfer element that is located in the movement pathway of the material output unit of a building material layer to be subsequently deposited, which is at least temporarily pushed out of the print pathway by the material output unit, while the material output unit deposits the building material along the defined print pathway of a (vertically) deeper building material layer.

However, it can also be provided that no lower building material layer is present, for example if the current print pathway is the first print pathway.

According to a development of the described embodiments, it can be provided that the at least one load transfer element is connected to the reinforcement via a joint connection. The joint connection can be designed, for example, in the manner of a film hinge, i.e., in particular by a cross-sectional tapering of the load transfer element.

Alternatively or additionally, it can be provided that the at least one load transfer element is at least sectionally elastic (e.g., in the region of one of its ends or also in a central region), in particular in order to enable a deflection of the load transfer element transversely to its longitudinal axis.

In a further development of the described embodiments, it can be provided that the joint connection and/or the sectionally elastic section of the load transfer element are designed to enable a displaceability of the section of the load transfer element extending into the print pathway by the material output unit.

The deformability or the elasticity of the load transfer element or the joint connection can be selected in such a way that the load transfer element can be displaced by the material output unit from the movement pathway of the material output unit and can bend in a sufficiently reversible manner for this purpose, preferably but not necessarily without experiencing an (irreversible) plastic deformation.

Preferably, when the material output unit has moved further along the print pathway, the at least one load transfer element subsequently experiences a restoring force and independently moves at least substantially, and particularly preferably completely, back to the original position and orientation.

According to a development, it can be provided that the joint connection and/or the sectionally elastic section of the load transfer element are designed to enable an automatic return of the section of the load transfer element displaced out of the print pathway by the material output unit.

Preferably, the at least one load transfer element is pivotable at least in the direction of the print pathway or counter to the direction of the print pathway. For this purpose, the at least one load transfer element can have a vertically extending pivot axis which preferably runs parallel to the vertical struts of the reinforcement or to the perpendicular on the base.

The load transfer element can be pivotable, or the vertical pivot axis can be positioned such that the load transfer element can be pivoted out of the movement pathway of the print head. The load transfer elements can therefore be in a resting state in a plan view of the base in the print pathway (including irrespective of the actual height position).

In an advantageous development of the described embodiments, it can be provided that the at least one load transfer element is formed from a rust-free material.

The use of a rust-free material for the design of the at least one load transfer element has proven to be particularly suitable, since the building material coverage or concrete coverage of the load transfer element is generally comparatively small, since the load transfer element extends into the print pathway (or even beyond). The load transfer element can therefore be particularly susceptible to later corrosion. In order to avoid the corrosion along the load transfer element spreading to the reinforcement, the use of a rust-free material can be advantageous. However, the use of a rust-free material is not absolutely necessary, for example if the reinforcement itself is made from a rust-free material, or if a subsequent corrosion of the load transfer element is not important.

In an advantageous development of the described embodiments, it can be provided that the at least one load transfer element is formed from a plastic, a sheet metal material, a textile, a metal (e.g., steel or iron) or a combination of the mentioned materials. This list is not intended to be exhaustive.

The at least one load transfer element can also be formed from individual fibers or fiber strands (for example from glass fibers, carbon fibers, etc.), even from fibers of a basically brittle material.

A fiber composite material, for example a combination of a plastic and textile fibers, such as Kevlar fibers, can be particularly suitable. Kevlar fibers and fiber bundles can in principle be highly suitable since they are not able to stretch much in length. A composite material with a plastic matrix can also be designed to be sufficiently flexible.

According to a development of the described embodiments, it can be provided that the material output unit is fastened to an end effector of an actuator device and is moved by the actuator device along the print pathway.

The end effector is preferably designed as a trolley of an actuator device designed as a gantry crane unit. Such a system is also known under the term “portal printer.”

However, the end effector can also be designed as an end effector of a robot, in particular an industrial robot. For example, a six-axis robot or another movement system, for example a hexapod or a five-axis system, or a combination of several movement units can be provided in order to move the material output unit.

The material output unit can be moved in at least one degree of translational freedom, preferably in at least two degrees of translational freedom, to discharge the building material, in particular by the actuator device. Given the possibility of movement along two translational degrees of freedom, a straight wall of a structure or a formwork component of a formwork can be manufactured additively, for example.

It is preferably provided that the material output unit is moved in all three degrees of translational freedom in order to dispense the building material. In particular, a material output unit movable along all translational degrees of freedom enables flexible manufacture of any three-dimensional structures or three-dimensional components of structures on the base.

The material output unit can even be moved in at least four degrees of freedom, in particular in all three translational degrees of freedom and at least one degree of rotational freedom. Particularly preferably, a movement along five degrees of freedom (preferably all three translational degrees of freedom and two rotational degrees of freedom) and very particularly preferably along all six degrees of freedom can be provided. In particular if the material output unit is movable in all translational degrees of freedom and in addition in one or more rotational degrees of freedom, the individual print paths can be deposited with the greatest flexibility. In this way, the geometry of the component can be predefined virtually as desired. For example, a tilting of the material output unit and/or a rotation of the material output unit can be provided during the deposition of the building material.

In an advantageous development of the described embodiments, it can be provided that the material output unit is oriented vertically or orthogonally to the base on which the component is erected, while the material output unit is moved along the print pathway and deposits the building material.

Vertical deposition of the building material is technically particularly easy to implement and generally leads to a particularly good result. In particular if the at least one load transfer element is displaceable by the material output unit from the movement pathway, a vertical deposition of the building material within the scope of the described embodiments can be advantageously suitable.

In an advantageous development of the described embodiments, it can be provided that the material output unit is oriented obliquely to parallel to the base on which the component is erected, while the material output unit is moved along the print pathway and deposits the building material in the direction of the reinforcement.

An oblique deposition of the building material can be provided in particular when the at least one load transfer element is designed rigid. By an oblique or parallel deposition, a collision with the material output unit can also be avoided, wherein the building material can nevertheless be deposited on the load transfer elements of the current layer located in the print pathway.

The material output unit can be designed to dispense the building material in a defined form, for example in print paths with rectangular or round edges. In cross section, the individual print paths can be, for example, discharged rectangular (square or elongated), round or oval. The material output unit preferably outputs the building material in the provided wall thickness of the component to be printed.

The material output unit can optionally have lateral guide legs, in particular two opposing guide legs, in order to laterally stabilize and/or form the building material while being discharged.

It can be provided that the material output unit is designed to selectively deposit print paths with a varying cross-sectional geometry, and/or the material output unit can be replaced manually or preferably automatically, wherein each material output unit is configured for depositing print paths with a specific cross-sectional geometry.

It can optionally also be provided that the material output unit is designed to selectively deposit print paths of different building materials and/or that the material output unit can be replaced manually or preferably automatically, wherein each material output unit is configured for depositing a specific building material. The flexibility of the method can be further improved by the possibility of depositing different building materials and/or different cross-sectional geometries.

The described embodiments also relate to a computer program comprising control commands which, when the program is executed by a control device, cause the latter to execute a method according to the above and subsequent embodiments.

The control device can be designed as a microprocessor. Instead of a microprocessor, any other device for implementing the control device can also be provided, for example one or more arrangements of discrete electrical components on a printed circuit board, a programmable logic controller (PLC), an application-specific integrated circuit (ASIC) or another programmable circuit, for example also a field programmable gate array (FPGA), a programmable logical arrangement (PLA) and/or a commercially available computer.

The described embodiments also relate to a load transfer element which extends along a longitudinal axis for load transfer along the longitudinal axis, preferably for use within an additively manufactured component. It is provided that the load transfer element has a joint connection and/or at least one elastic section in order to enable a pivoting movement of the load transfer element transversely to the longitudinal axis.

The described embodiments also relate to a reinforcement for use within a component, in particular within an additively manufactured component having at least one load transfer element projecting laterally from the reinforcement.

It can be provided that the at least one load transfer element is connected to the reinforcement via a joint connection and/or is at least sectionally elastic.

The described embodiments also relate to an additively manufactured component, produced by a method according to the above and subsequent embodiments, having a reinforcement which is enveloped by a building material applied in layers.

Finally, the described embodiments also relate to a device of additively manufacturing a component from a building material which is designed for caring out a method according to the above and following embodiments. The device has in particular a material output unit for the building material in order to deposit the building material in layers along a defined print pathway.

Features described in connection with one of the objects of the described embodiments, namely given by the method according to the described embodiments, the computer program, the reinforcement, the additively manufactured component and the device, are also advantageously implementable for the other objects of the described embodiments. Likewise, advantages that were mentioned in connection with one of the subjects of the described embodiments can also be understood in relation to the other subjects of the described embodiments.

In addition, it should be pointed out that terms such as “comprising,” “having,” or “with” do not exclude any other features or steps. Furthermore, terms such as “one” or “the” which refer to a single number of steps or features do not exclude a plurality of features or steps—and vice versa.

In a puristic embodiment, however, it may also be provided that the features introduced in the described embodiments by the terms “comprising,” “having” or “with” are exhaustively enumerated. Accordingly, one or more enumerations of features may be considered complete within the scope of the described embodiments, for example, each considered for each claim. The described embodiments can consist, for example, exclusively of the features mentioned in claim 1.

It should be noted that designations such as “first” or “second,” etc., are used primarily for purposes of distinguishing respective device or process features and are not necessarily intended to imply that features are mutually dependent or interrelated.

Furthermore, it should be emphasized that the values and parameters described herein include deviations or fluctuations of ±10% or less, preferably ±5% or less, more preferably ±1% or less, and very particularly preferably ±0.1% or less of the named value or parameter, provided that these deviations are not ruled out in practice in the implementation of the described embodiments. The indication of ranges by initial and end values also comprises all those values and fractions which are enclosed by the designated range, in particular the initial and end values and a respective average value.

The described embodiments also relate to a method of additively manufacturing a component from a building material, according to which a material output unit deposits the building material in layers along a defined print pathway. It is provided here that at least one load transfer element extends into the print pathway, wherein the material output unit deposits the building material onto the load transfer element located in the print pathway. The additional features described in the present description relate to advantageous embodiments and variants of this method. In particular, alternatively or in addition to the movement of the at least one load transfer element by the material output unit, the material output unit can also be displaceable when it comes into contact with a load transfer element.

Exemplary embodiments are described in more detail below with reference to the drawing.

### BRIEF DESCRIPTION OF THE DRAWINGS

The figures each show preferred embodiments in which individual features of the present described embodiments are shown in combination with one another. Features of an embodiment can also be implemented separately from the other features of the same embodiment and can accordingly be easily combined with features of other embodiments by a person skilled in the art to form further useful combinations and subcombinations.

In the figures, functionally identical elements are provided with the same reference signs.

In the figures, schematically:

FIG. 1 shows a material output unit during the deposition according to the described embodiments of a building material for additive manufacturing of a formwork component in multiple building material layers along a reinforcement with multiple load transfer elements extending into the print pathway;

FIG. 2 shows the additive manufacturing of a formwork around a reinforcement with the load transfer elements;

FIG. 3 shows a material output unit that deposits the building material vertically adjacent to the reinforcement;

FIG. 4 shows a material output unit which deposits the building material obliquely adjacent to the reinforcement; and

FIG. 5 shows an individual representation of a load transfer element connected via a joint connection to a vertical strut of the reinforcement.

### DETAILED DESCRIPTION

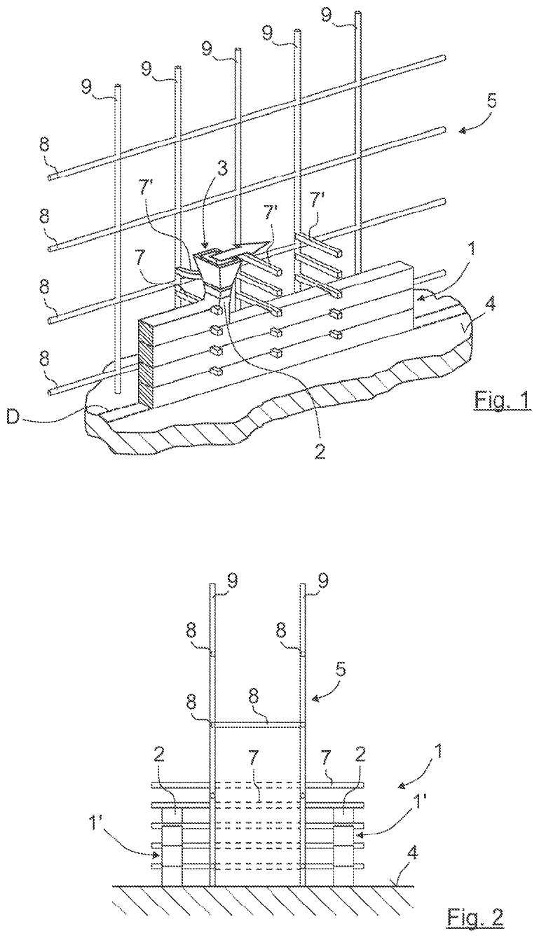

In FIG. 1, the principle of the method according to the described embodiments is indicated by way of example and schematically. Of additively manufacturing a component 1 from a building material 2, a material output unit 3 is provided which deposits the building material 2 in layers along a defined print pathway D. The print pathway D is dashed in FIG. 1, and the movement of the material output unit 3 is indicated by an arrow.

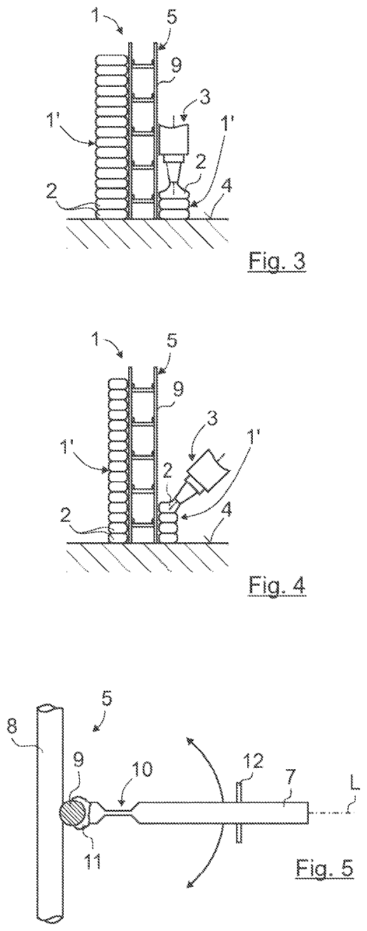

The additively manufactured component can in particular be a formwork 1 made of two formwork components 1′ extending parallel to one another (cf., for example, FIGS. 3 and 4). However, the described embodiments are suitable in principle for the manufacture of any component 1 or even an entire structure and is therefore not to be understood to be limited to the production of a formwork 1 or a formwork component 1′. However, the described embodiments are particularly advantageous for entering a so-called “lost” formwork 1 which is optionally (but not necessarily) filled with an additional building material (not shown) and which forms a component of the later component.

The building material 2 for additive manufacturing and/or the additional building material can in particular be a flowable mixed concrete. In principle, however, any building material 2 can be provided, for example also a plastic or plaster.

The component 1 can be erected on a base 4. The print pathway D extends at least sectionally along a reinforcement 5 which, for example, can have a reinforcement mat (cf. FIG. 1) or an entire reinforcement cage (cf. FIG. 2 to 4). The reinforcement 5 can be placed on the base 4 and optionally connected to the base 4, for example via a so-called connecting reinforcement (not shown).

Preferably, the print pathway D is spaced apart from the reinforcement 5, as shown in FIGS. 1 and 2. However, this is not necessarily what matters.

At least one load transfer element 7 is provided, which extends from the reinforcement 5 to the print pathway D, wherein the material output unit 3 deposits the building material 2 onto the load transfer element 7 located in the print pathway D, which can be seen particularly well in FIG. 1.

The reinforcement 5 can be arranged between two parallel print paths D as is shown, for example, in FIG. 2. At least one load transfer element 7 can then be provided on each side of the reinforcement 5. However, load transfer elements 7 can also be provided which extend from one side of the reinforcement 5 to the other side of the reinforcement 5, that is to say project into both print paths D. This is indicated in a dashed line in FIG. 2.

The at least one load transfer element 7 can be attached to the reinforcement and/or rest on two horizontal struts 8 of the reinforcement 5 positioned offset from one another.

It can be provided that the at least one load transfer element 7 extends beyond the print pathway D in order to protrude laterally from the finished component 1 after the deposition of the building material 2 (cf. FIGS. 1 and 2). The load transfer element 7 can, however, also be completely covered on the side by the building material 2, which is basically preferred.

Preferably, several of the load transfer elements 7 are arranged distributed along the print pathway D and distributed over several layers to be deposited. The use of as many load transfer elements 7 as possible can lead to a uniform and gentle load transfer. In particular, multiple load transfer elements 7 can be provided per layer to be deposited, preferably a respective load transfer element 7 per vertical strut 9 of the reinforcement 5, as can be clearly seen in FIG. 1. However, it can also be provided, for example, that a load transfer element 7 is provided only for each second vertical strut 9 of the reinforcement 5, only for each third vertical strut 9 of the reinforcement 5, or only for each fourth vertical strut of the reinforcement 5. All the information given here is to be understood as examples only.

At this point it should be mentioned that the number or density of the load transfer elements 7 in the later component 1 can result from the diameter of the load transfer elements 7. The smaller the diameter of the load transfer elements 7, the more load transfer elements 7 can generally be advantageously provided.

In a preferred variant, it can be provided that a load transfer element 7′ located in the acute movement pathway of the material output unit 3 (cf. FIG. 1) of a subsequent or higher building material layer can be displaced by the material output unit 3 at least temporarily from the print pathway D, while the material output unit 3 deposits the building material 2 along the current print pathway D. By way of example, FIG. 1 shows how the material output unit 3 moves or bends one of the load transfer elements 7′ from its movement pathway. Subsequently, the load transfer element 7′ can move back into its original position due to an elastic restoring force.

The load transfer elements 7 can, for example, be connected to the reinforcement 5 via a joint connection 10. An exemplary joint connection 10 in the manner of a film hinge is shown in FIG. 5. The joint connection 10 or the film hinge can be formed by a cross-sectional tapering and in particular enable a movement along or opposite the print pathway D/feed direction of the material output unit 3 (cf. arrows in FIG. 5).

It can also be provided that the load transfer elements 7 are formed elastically at least on a section of their longitudinal axis L (cf. FIG. 5), in particular in order to enable bending/pivoting transversely to the longitudinal axis L. In principle, the load transfer elements 7 can also be designed to be completely elastic—even an elastic embodiment of one of the ends or of a central part can be sufficient, however.

The load transfer element 7 can in principle be connected to the reinforcement 5, for example a vertical strut 9 of the reinforcement 5, in any desired manner. A welded connection 11 is indicated in FIG. 5.

Optionally, as is also indicated in FIG. 5, the load transfer element 7 can have cross struts 12 or other anchor elements in order to produce an even better connection to the respective building material layer. Recesses or cross-sectional tapers can also optionally be provided.

Preferably, the load transfer element 7 is formed from a rust-free material. For example, the load transfer element 7 can be made of a plastic, a sheet metal material (in particular a rust-free sheet metal material), a textile or a composite material, in particular a combination of the mentioned materials.

The material output unit 3 can be fastened to an end effector, not shown in greater detail, of an actuator device, which is likewise not shown. A corresponding device for the additive manufacturing of the component can be designed, for example, as a so-called portal printer. The actuator device is capable of moving the end effector or the material output unit 3 along the print pathway D in preferably several degrees of freedom.

To deposit the building material 2, it can be provided that the material output unit 3 is oriented vertically relative to the base 4 on which the component 1 is erected (cf. FIG. 3). For simpler illustration, the load transfer elements 7 are not shown in FIGS. 3 and 4. Vertical deposition is particularly suitable when the load transfer elements 7 are designed flexible and are displaceable by the material output unit 3, as shown in FIG. 1.

In particular when the load transfer elements 7 are designed rigid, an oblique to parallel alignment of the material output unit 3 relative to the base 4 can also be suitable in order to deposit the building material 2 in the direction of the reinforcement 5, as indicated in FIG. 4. In this way, a collision between the material output unit 3 and load transfer elements 7 of higher building material layers can be avoided.

In particular, it can also be provided that the orientation of the material output unit 3 is flexibly adjustable during additive manufacturing.

1. Method of additively manufacturing a component from a building material, according to which a material output unit deposits the building material in layers along a defined print pathway,
wherein
at least one load transfer element extends into the print pathway, wherein the material output unit deposits the building material onto the load transfer element located in the print pathway, wherein a load transfer element located in a movement pathway of the material output unit is at least temporarily pushed out of the print pathway by the material output unit, while the material output unit deposits the building material along the defined print pathway.

2. Method according to claim 1,
wherein
the print pathway extends at least sectionally along a reinforcement, starting from which the at least one load transfer element extends into the print pathway.

3. Method according to claim 1,
wherein
two formwork components are produced extending parallel to one another for forming a formwork.

4. Method according to claim 3,
wherein
the formwork is filled with an additional building material.

5. Method according to claim 1,
wherein
concrete or flowable mixed mortar is used as the building material.

6. Method according to claim 2,
wherein
the print pathway extends at least sectionally parallel to a course of the reinforcement on a base, and is spaced apart from the reinforcement.

7. Method according to claim 2,
wherein
the reinforcement has a reinforcement mat, and/or a reinforcing cage, and/or a reinforcement rod, and/or a reinforcing wire.

8. Method according to claim 2,
wherein
the at least one load transfer element is fastened to the reinforcement and/or rests on two horizontal struts of the reinforcement positioned offset from one another and/or is fastened to a holder and/or rests on a holder.

9. Method according to claim 2,
wherein
the reinforcement is arranged between two parallel print paths, wherein
a) at least one of the load transfer elements extends through the reinforcement from a first print pathway to a second print pathway, and/or
b) separate load transfer elements are provided on each side of the reinforcement and each extend into an associated one of the first print pathway and the second print pathway.

10. Method according to claim 1,
wherein
the at least one load transfer element extends beyond the print pathway in order to protrude laterally from the component after the building material has been deposited.

11. Method according to claim 1,
wherein
multiple ones of the load transfer elements are arranged distributed along the print pathway and/or are arranged distributed over multiple the layers to be deposited.

12. Method according to claim 1,
wherein
the load transfer element pushed out of the print pathway is a load transfer element of a building material layer to be subsequently deposited which is pushed out of the print pathway by the material output unit, while the material output unit deposits the building material along the defined print pathway of a deeper building material layer.

13. Method according to claim 2,
wherein
the at least one load transfer element is connected to the reinforcement via a joint connection and/or is formed elastically at least sectionally in a direction of the print pathway.

14. Method according to claim 13,
wherein
the joint connection and/or the sectionally elastic portion of the load transfer element are designed to enable a displaceability of the section of the load transfer element extending into the print pathway through the material output unit.

15. Method according to claim 13,
wherein
the joint connection and/or the sectionally elastic section of the load transfer element are designed to enable an automatic return of e section of the load transfer element displaced out of the print pathway by the material output unit.

16-17. (canceled)

18. Method according to claim 1,
wherein
the material output unit is fastened to an end effector of an actuator device and is moved by the actuator device along the print pathway.

19. Method according to claim 1,
wherein
the material output unit is oriented vertically to a base on which the component is erected, while the material output unit is moved along the print path and deposits the building material.

20. Method according to claim 2,
wherein
the material output unit is oriented obliquely to parallel to a base on which the component erected, while the material output unit is moved along the print pathway and deposits the building material in a direction of the reinforcement.

21. (canceled)

22. Load transfer element extending along a longitudinal axis for load transfer along the longitudinal axis,
wherein
the load transfer element has a joint connection and/or at least one elastic section in order to enable a pivoting movement of the load transfer element transversely to the longitudinal axis, and wherein
the joint connection and/or the sectionally elastic section of the load transfer element are designed to enable an automatic return of the section of the load transfer element displaced out of a print pathway by a material output unit that deposits building material in layers along the print pathway.

23. Reinforcement for use within a component, in particular within an additively manufactured component, having at least one load transfer element, which projects laterally from the reinforcement, according to claim 22.

24. (canceled)
